(19) United States
(12) Patent Application Publication
(10) Pub. No.: US 2012/0051242 A1
(43) Pub. Date: Mar. 1, 2012

(54) SYSTEM PROVIDING ASSISTANCE IN THE DEPLOYMENT OF A FIXED NETWORK FOR THE REMOTE READING OF METERS

(75) Inventors: Vincent Rigomier, Saint Martin Belle Roche (FR); Michel Bottner, Charnay Les Macon (FR)

(73) Assignee: ITRON FRANCE, Boulogne-Billancourt (FR)

(21) Appl. No.: 13/203,370

(22) PCT Filed: Mar. 8, 2010
(86) PCT No.: PCT/EP10/52890

§ 371 Date: Nov. 16, 2011

(30) Foreign Application Priority Data
Mar. 13, 2009 (EP) EP 09305234.8

(51) Int. Cl. H04W 24/00

(52) U.S. Cl. 370/252

(57) ABSTRACT

The invention proposes a system for assisting deployment of a fixed remote meter reading network, in which system an access point is to recover measurement data from meters (1) by radio, said data being transmitted via a radio communication module (2) associated with each meter and being relayed to the access point via at least one intermediate collector. The system enables an installer to be equipped with a portable device enabling in situ validation of future positions for intermediate collectors. The device includes a measurement mobile unit (6) for simulating the radio receiver operation of an intermediate collector capable, in an access point/collector mode (M₁), of communicating by radio with a first mobile unit (3) for simulating the operation of the access point in a collector/collector mode (M₂) with a second mobile unit (4) for simulating the operation of the intermediate collector and, in a listening mode (M₃), of intercepting a response radio signal transmitted by a communication module (2) following interrogation by a remote meter reading portable unit (5). In the three modes, the measurement unit measures the intensity of the received or intercepted signal. The modes are triggered by radio from a portable radio control and display unit (7) that displays information relating to the quality of the link based on the measurement.

The present invention relates to remote reading of domestic or industrial water, gas, heat, and electricity meters each associated with a radio communication module.

At present there exist several types of network enabling remote meter reading by radio:
So-called “walk by” remote meter reading networks, in which a person called the meter reader travels on foot, whence “walk by”, and has a portable terminal or computer provided with a radio interface, for example a unit of the type sold by the Applicant under the registered trade mark Easyco for a water meter. When the meter reader passes near a meter or a group of meters each including a radio communication module (for example a module of the type sold by the Applicant under the registered trade mark Cyble), the terminal interrogates the meter or meters by sending a wake-up signal instructing the meter or meters to send their data. The distance between the reader and the meter or meters is rarely more than about one hundred meters. The wake-up signal is sent to meters within its coverage area and the meters respond by sending a response signal to the portable computer. Radio communication between the module in the meters and the portable computer is bidirectional, i.e. may be set up in the direction from the module to the computer and vice-versa.
So-called “drive by” remote meter reading networks, which are similar to walk-by networks, except that the reader travels in a vehicle.
So-called “fixed” remote meter reading networks, in which meters equipped with radio communication modules generally do not communicate with the computer directly but via an access point or main collector and one or more repeater intermediate collectors responsible for relaying signals between the radio communication modules and the access point or main collector. In this type of network, radio communication may be unidirectional (from the radio communication modules to the main collector via intermediate collectors serving as repeaters) or bidirectional.

Attention is given below only to so-called fixed networks, which at present are favored by operators in particular because they do not require any movement of persons to effect remote meter reading.

Attention is more particularly given to laying out these fixed networks in the context of either deploying a new network or extending an existing network, requiring precise definition of the best geographical locations for radio communication modules, repeater intermediate collectors, and the access point or main collector.

The positions of the various meters, and consequently of the associated radio communication modules, are set by the service (water, electricity, or gas) distribution network. Usually, because it must be supplied with power via the electrical mains, the geographical location of the access point or main collector is also imposed.

Consequently, the problem in deploying a fixed network is choosing positions for the repeater intermediate collectors that guarantee a radio link level with sufficient margin as well as minimizing the number of repeater intermediate collectors used to transfer data from the meters to the access point or main collector.

At present there are essentially two known methods of assisting deployment of a fixed remote meter reading network:

In a first known method the number of repeater intermediate collectors to be positioned is estimated using a map. This solution is not satisfactory, however, for the following reasons:
since radio propagation is not an exact science, communication distances vary as a function of the position of the meter (meter pit, landing box, etc.) and the environment (wall types, habitat density, etc.), and it is necessary to define beforehand propagation models for estimating distances as a function of the characteristics of the terrain; and
these models are not able to define the safety margin for radio communication before the network is installed.

Another known solution consists in effecting radio link surveys in situ using standard radio measurement instrumentation, such as a frequency generator and a spectrum analyzer, to measure transmission power losses. This solution is no more satisfactory, however, because it requires specialist personnel with radio experience, both to operate the measurement instrumentation and more importantly to interpret the results. In particular, in order to comply with the margin tolerated by the equipment that is to be installed, direct deduction cannot be drawn from the results in terms of power loss. Moreover, the measurement instrumentation is physically and structurally very different from the equipment that is to be installed, and so transmission losses measured in this way may not reflect actual transmission losses once the network has been installed.

The object of the present invention is to make a simple system available to installers with no specialist radio skills, providing them with assistance in deploying a fixed remote meter reading network and able to determine optimum future positions for pieces of network equipment, in particular repeater intermediate collectors, and able to optimize the amount of network equipment necessary to cover the network.

The invention achieves this object and firstly provides a system conforming to claim 1 for assisting in the deployment of a fixed remote meter reading network.

The use of such a system preferably consists in implementing the steps of claim 9.

Other features and advantages of the invention become apparent in the light of the following description of a system of the invention and its use in the context of assisting deployment of a fixed remote meter reading network, given with reference to the appended figures, in which:

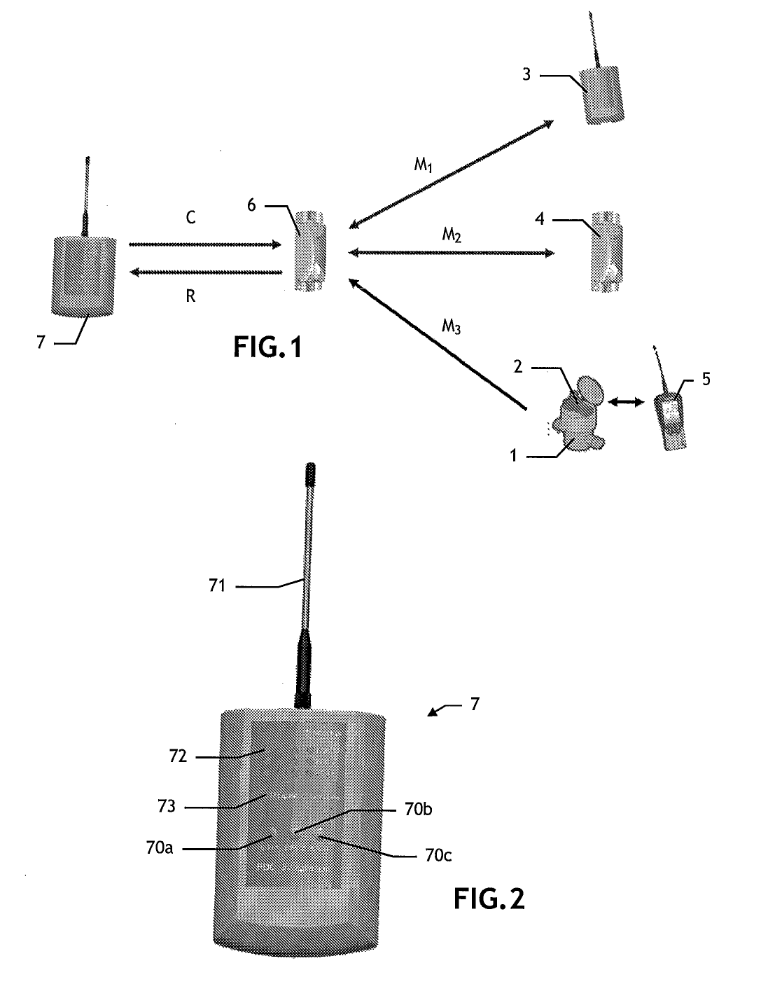

FIG. 1 shows diagrammatically the components of a system of the invention for assisting deployment of a fixed remote meter reading network and their interaction;

FIG. 2 shows in more detail an example of a control and display portable unit of the system from FIG. 1; and

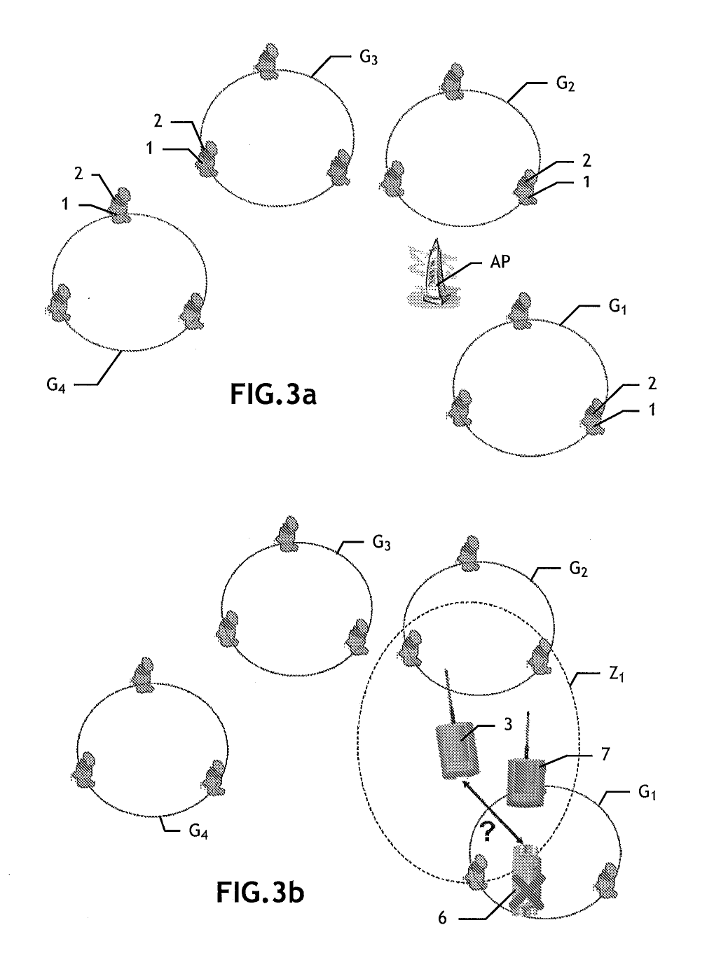

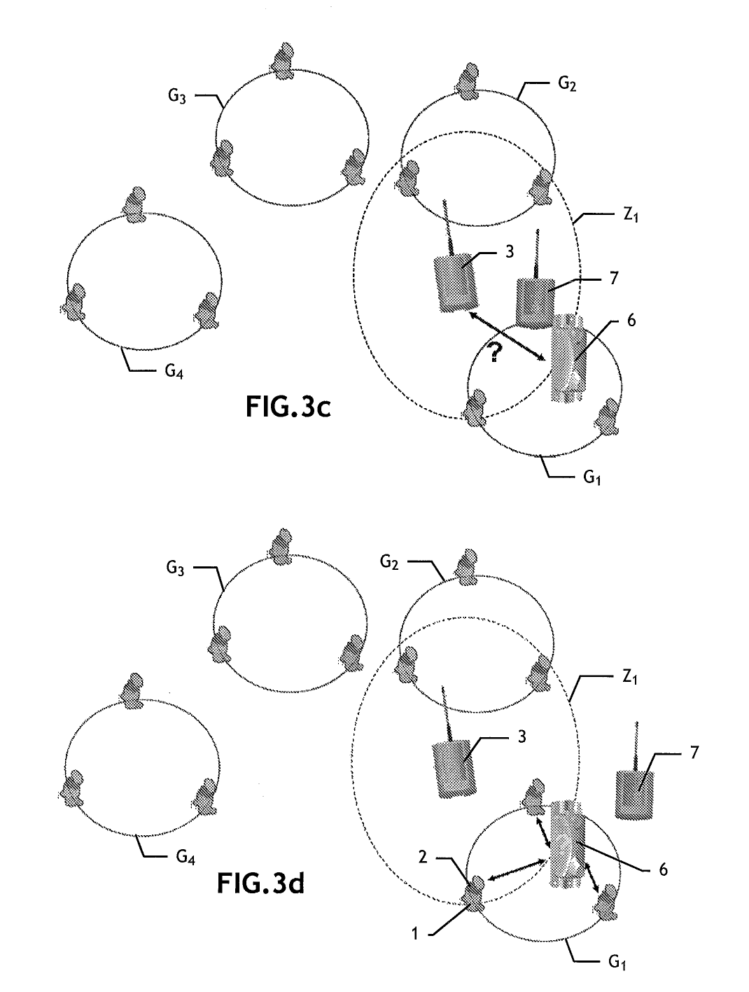

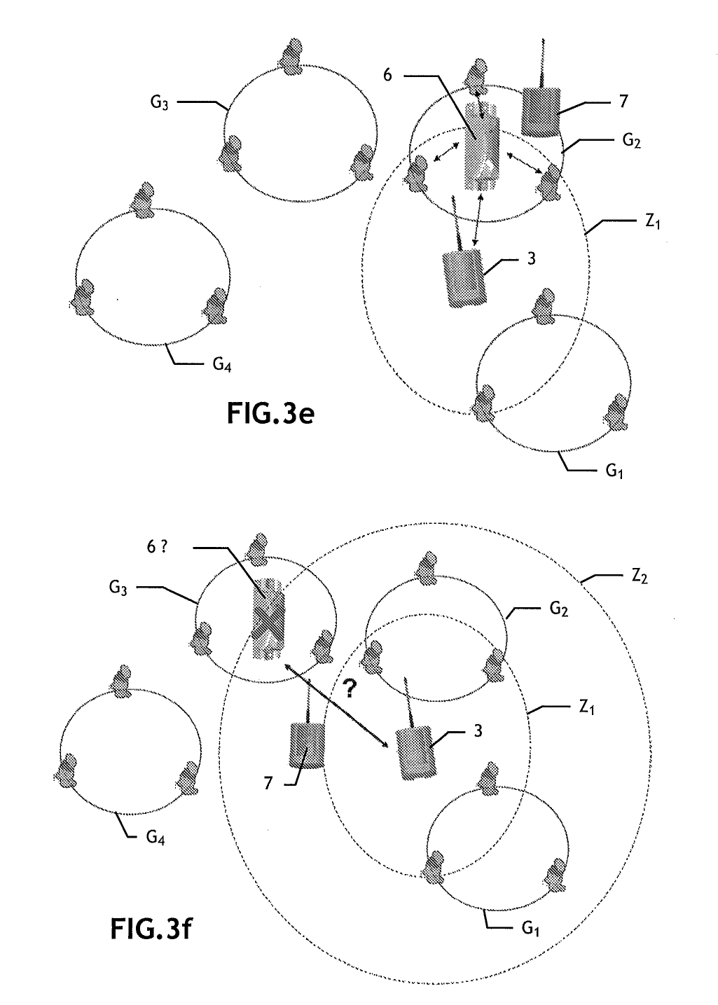

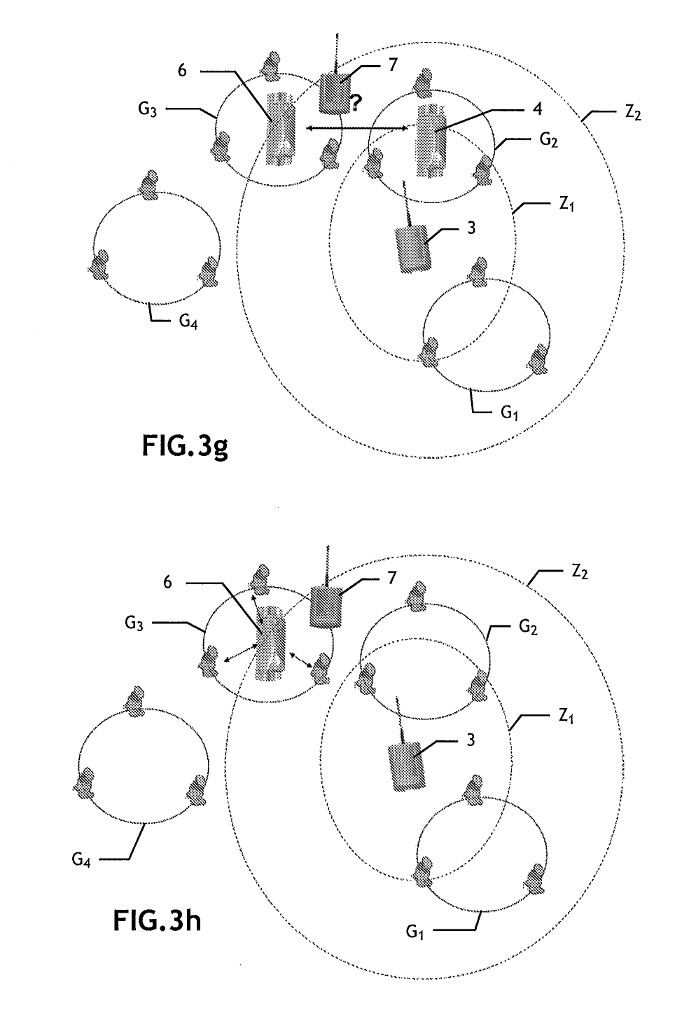

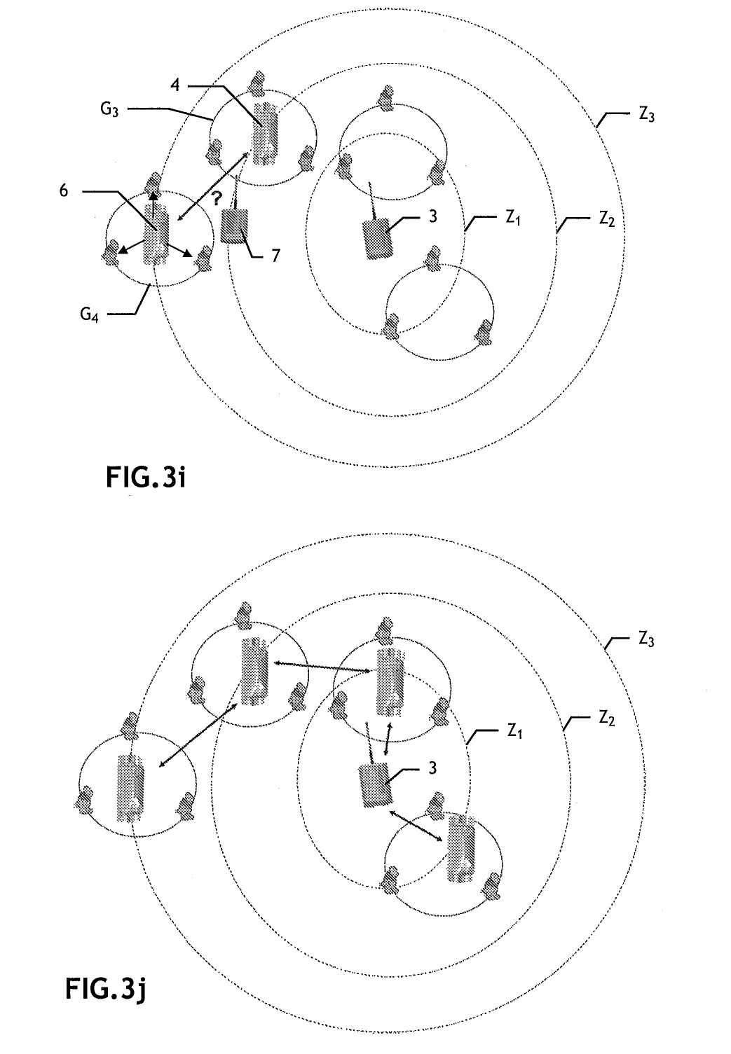

FIGS. 3a to 3j show the steps of using the system of the invention for assisting deployment of one example of a fixed network.

The components of a system for assisting deployment of a fixed remote meter reading network and their interaction are described below with reference to FIG. 1. The fixed network to be deployed is of the type allowing an access point or main collector to recover measurement data from a plurality of meters 1 by radio. This data is transmitted by a radio communication module 2 associated with each meter and relayed to said access point or main collector via at least one intermediate collector. By way of non-limiting example applying to remote reading of water meters, the radio communication modules 2 could be those sold by the Applicant under the registered trade mark Cyble.

The system for defining very precisely optimum future geographical locations for the pieces of network equipment, in particular the access point and the intermediate collectors, includes the following components:
a first mobile unit 3 able to simulate the radio operation of said access point or main collector;
a second mobile unit 4 able to simulate the radio receiver and repeater operation of an intermediate collector;
a remote meter reading portable unit 5 able to exchange data with each radio communication module 2, with said unit being for example of the type sold by the Applicant under the registered trade mark Easyco for networks of the “walk by” type as described above;
a measurement mobile unit 6 able in particular to simulate the radio reception operation of an intermediate collector; and
a portable radio control and display unit 7.

The term “mobile unit” refers to a unit that is intended to occupy a fixed position, but that is adapted to be moved to geographically different positions, because of its small overall size.

The term “portable unit” refers to a unit intended to be carried by the installer while it is in use.

The term “to simulate” means to behave like the future network equipment, faithfully reproducing its radio propagation behavior.

Accordingly, the first mobile unit 3 must replace as faithfully as possible the access point or main collector that it is called on to represent. To this end, the radio interface, and in particular the antenna used, must be the same as those equipping a real access point. To reproduce its behavior faithfully, it is also attempted, as far as possible, to design a first mobile unit that has substantially the same overall size as the real main collector, in particular so as to be able to occupy the same positions and to have the same antenna orientations as the real main collector, and thus to reproduce the same radio behavior.

The second mobile unit 4 must also replace as faithfully as possible an intermediate collector that it is called on to represent. Thus its radio operation must be testable, both when receiving information and when relaying information. By way of example, it is possible to use an actual intermediate collector that is used only for assisting deployment, or else equipment that is similar in terms of radio operation and overall size. Here again, the antenna and the radio performance must be identical to those of the intermediate collectors and the shape of the unit must be sufficiently similar to that of a real collector to be able to assume positions and antenna orientations that optimally reflect reality.

The mobile unit 6, the importance of which becomes clear below, must reproduce as faithfully as possible radio reception by an intermediate collector. In respect of this function, this unit is not very different from the second mobile unit 4. Again, and for the reasons stated above, the antenna must be identical to that used in the intermediate collectors and the shape of the unit must be sufficiently similar to that of a real collector to reproduce faithfully its radio propagation behavior.

Moreover, according to the invention, the portable unit 7 is able to control the operation of the measurement mobile unit 6 by radio in three distinct operating modes:

The first mode is an access point/collector mode M₁ in which the measurement mobile unit 6 initiates radio communication with the first mobile unit 3 simulating the operation of the access point, after which it effects a measurement indicative of the intensity of the signal that it receives from the first mobile unit 3 during this exchange.

The second mode is a collector/collector mode M₂ in which the measurement mobile unit 6 initiates radio communication with the second mobile unit 4 simulating the operation of the intermediate collector and effects a measurement indicative of the intensity of the signal that it receives from the second mobile unit 4 during this exchange.

The third mode is a listening mode M₃ in which the measurement mobile unit 6 intercepts a response signal transmitted by a radio communication module 2 in response to an interrogation signal sent by the portable remote meter reading unit 5 and effects a measurement indicative of the intensity of the intercepted signal.

Consequently, all tests carried out by the measurement mobile unit 6 are radio controlled (commands C) by the portable unit 7. In the above-mentioned three modes M₁ to M₃, measurements carried out by the measurement mobile unit are of the RSSI (received signal strength indication) type, for example.

Whichever operating mode M₁ to M₃ is used, the measurement effected by the measurement mobile unit 6 is transmitted in the form of a radio signal R to the portable unit 7, which is adapted to receive this measurement.

The portable unit 7 contains programs for responding to the measurement received in this way to produce information relating to the quality of the radio link determined from said measurement. This information, which takes into account the imposed safety margins in terms of radio link quality, is directly usable by the installer to decide whether or not a tested location offers sufficient quality for a future network layout. To this end, the portable unit 7 includes means 72 for displaying this information.

FIG. 2 shows a possible construction detail of a portable radio control and display unit 7, showing the user interface of the portable unit.

To enable the installer to select and launch tests in any of the above-mentioned three modes M₁ to M₃, it advantageously includes three manual control buttons 70a-70c. This addresses concerns about optimized cost and simplicity, but the control interface could of course be more complex, and for example it could use selection via a pull-down menu appearing on a display screen.

The unit 7 further includes a radio antenna 71 for sending radio control commands C and for receiving signals R including measurements made by the measurement mobile unit 6 in one of the three modes M₁ to M₃.

In this example, the display means of the portable unit 7 include light-emitting diodes 72. In the preferred embodiment shown in FIG. 2, the display means include three sets of light-emitting diodes, each set being assigned to the display of information relating to the quality of the link in one of the three operating modes. For example:
the first row of four diodes situated in the upper part of the portable unit 7 serves to display information relating to the quality of the link when the measurement mobile unit 6 is operating in mode M₁;
the second row of four diodes serves to display information relating to the quality of the link when the measurement mobile unit 6 is operating in mode M₂; and
the third row of four diodes serves to display information relating to the quality of the link when the measurement mobile unit 6 is operating in mode M₃.

To enable direct interpretation by the installer, the number of diodes lit in each set is a function of the quality of the link. For example, the portable unit may be calibrated so that if at least the two left-most diodes of each set are lit, then the installer may directly conclude that the radio link under test is satisfactory and may therefore validate a potential future geographical location.

Conversely, if no diode or only one diode is lit, the installer may conclude that the location is not satisfactory.

The diodes may furthermore be controlled so as to indicate other types of information to the installer. For example:
the left-most diode of each set could blink while a measurement is in progress;
the four diodes of the same set could blink if communication over the link under test has failed (mode M₁ or M₂) or the measurement mobile unit 6 has not intercepted any response signal (mode M₃); and
the left-most two diodes of the same set could begin to blink if communication between the portable unit 7 and the measurement unit 6 has failed.

It should be noted that other display interfaces could be used without departing from the scope of the invention: for example, direct display of a validation or non-validation message on a liquid crystal display screen could be envisaged. What is important here is to enable the installer directly to validate or invalidate a geographical location tested in situ.

It is preferable for no radio control commands C to be sent to the measurement unit 6 by the portable control unit 7 unless it has been verified that the frequency occupancy level would enable the test to be carried out correctly. If the frequency band is already occupied by another application, there is a risk of erroneous measurements. Also, the portable radio control and display unit 7 is advantageously adapted to measure automatically the frequency occupancy level used to communicate before any radio exchange between the portable unit 7 and the measurement mobile unit 6.

To enable the installer to decide how to proceed, the portable control and display unit 7 advantageously includes an additional light-emitting diode 73 that is lit if the frequency occupancy level is greater than a predetermined threshold. The installer then knows that measurement will need to be restarted.

By means of the invention, an installer with no particular radio skills may very simply carry out the tests and validate or invalidate geographical locations using the equipment available to them. The mobile and portable elements are preferably combined in a common carrying case to form an easily transportable kit.

The radio and software means used in each of the mobile and portable units constituting the system are not described in more detail, being standard and having no features specific to the invention. The various means of the same kit should nevertheless be matched, to prevent any interference with other kits or other radio systems. To this end, it is sufficient in particular:
if all radio control command messages C sent by the portable unit 7 include, preferably in a header, a unique identifier used to control a single measurement mobile unit 6 belonging to the same kit;
if all radio requests sent by the measurement mobile unit 6 to the mobile unit 4 for simulating the operation of an intermediate collector also include an identifier recognized only by that mobile unit 4;
if all radio responses sent by the mobile unit 4 for simulating the operation of an intermediate collector also include an identifier recognized only by the measurement mobile unit 6 from which the requests came; and
if the measurement mobile unit 6 is only able to listen (mode M₃) to response signals from the modules 2 via the portable remote meter reading unit 5 from the same kit.

The radio frequencies used for communication between the system components depend of course on the fixed network to be deployed. All radio communication are effected in the UHF band, for example, notably at 868 megahertz (MHz).

An example of use of the system of the present invention for assisting deployment of a network is described below with reference to FIGS. 3a to 3j, which show diagrammatically the successive steps carried out by an installer.

The starting point is the non-limiting assumption that the fixed network to be deployed is intended to cover the geographical configuration shown in FIG. 3a, this network being intended to transmit measurement data by radio to an access point or main collector, which data is delivered by a plurality of meters 1 via radio communication modules 2 associated with the meters 1. Here the positions of the meters, and therefore of the associated radio communication modules 2, are known and imposed by the distribution network. It is also assumed that the geographical location AP of the access point or main collector is also known and imposed.

It is seen in FIG. 3a that the meters are concentrated into several groups, four groups G₁ to G₄ in the example shown, which are situated more or less close to the access point location AP. To be more precise, the two groups G₁ and G₂ are situated in or at least partially covered by a first coverage area (Z₁ in FIGS. 3b et seq) of the access point location AP, the group G₃ is situated in a second coverage area (Z₂ in FIGS. 3f et seq), and the group G₄ is situated in a third coverage area (Z₃ in FIGS. 3i et seq).

Modeling on a map using prior art techniques could determine only the number of intermediate collectors necessary to deploy the network (as it happens four for the example shown here), but the system of the invention provides a very precise knowledge of the future geographical locations of the intermediate collectors.

Use of the system of the invention consists in determining successive preferred future locations for intermediate collectors, starting with first level collectors situated as close as possible to the access point and progressively determining the positions of higher level intermediate collectors on moving away from the access point.

The installer with a carrying case containing the network deployment assistance system preferably proceeds as follows:

a1) Initially, the installer goes to the access point location AP and places the first mobile unit 3 simulating the radio operation of said access point or main collector at the geographical location AP corresponding to the required or imposed future location of the access point or main collector of the network.

a2) The installer then proceeds to determine possible locations for first level intermediate collectors, i.e. those nearest the access point. To this end, it is necessary to determine the future geographical location of a first level intermediate collector for each group of radio communication modules associated with meters situated at least partially in a first coverage area of the access point (in this example the area Z₁ and the groups G₁ and G₂). This is done by using the access point/collector operating mode M₁ and the listening mode M₃ successively for one or more positions of the measurement mobile unit 6 and by recording position information corresponding to the first position of the measurement mobile unit 6 for which the information obtained on the display means of the portable unit 7 corresponds to a radio link of sufficient quality in the access point/collector operating mode M₁ and in the listening mode M₃.

a3) Potential locations for second level intermediate collectors are then determined; for this it is necessary, for each group of radio communication modules associated with meters situated at least partially in a coverage area of the access point larger than the first area, to determine the future geographical location of a second level intermediate collector by placing the second mobile equipment 4 in the position designated by the position information recorded at the first level (in this example this means the area Z₂ and the group G₃). This is done by successively using the collector/collector operating mode M₂ and the listening mode M₃ for one or more positions of the measurement mobile unit 6 and recording the geographical coordinates of the first position for which the information obtained on the display means of the portable unit 7 corresponds to a radio link of sufficient quality in the collector/collector operating mode M₂ and in the listening mode (M₃).

a4) Optimum future locations for collectors of even higher levels are determined in exactly the same manner, by repeating the preceding step a3) and testing the connections between the second mobile device 4 placed at one of the locations determined for a lower level and one or more potential locations of the measurement mobile unit 6 for the immediately higher level (in the example, this means the area Z₃ and the group G₄).

FIGS. 3b and 3c illustrate application of the steps a1) and a2) described above to deployment of the network in the context of FIG. 3a for the first group G₁ of meters 1. These two figures more precisely illustrate the situation in which the position judged optimum for the connection with the application point and for the radio communication modules has been determined for two successive positions of the measurement unit 6. As shown in FIG. 3b, in the step a2) the installer carries out the test for a first potential location for the measurement mobile unit 6. More precisely, the installer proceeds as follows:

a21) Placing the measurement mobile unit 6 at a first location (see FIG. 3b) in an area close to the group G₁ of radio communication modules 2 associated with the meters 1.

a22) Pushing the button 70a on the portable control and display unit 7, to cause the measurement unit 6 to operate in the access point/collector mode M₁; using the display means of the portable control and display unit 7 to verify whether the information received does or does not correspond to a radio link of sufficient quality between the first mobile unit 3 and the measurement unit 6; it is considered here that only one light-emitting diode 72 of the set of four diodes corresponding to this test lights; the installer then concludes directly, without having to interpret the results any further, that the location is not satisfactory.

a23) Moving the measurement mobile unit 6 to a second location, as shown in FIG. 3c, and repeating the test described under a22) for this new location; it is assumed here that three light-emitting diodes 72 light; the installer then concludes, again directly, that the location for the radio link between the first mobile unit and the measurement unit 6 is satisfactory this time.

a24) Verifying whether the radio link between the measurement unit 6 and the radio communication modules 2 of the group G₁ is also satisfactory (FIG. 3d); to this end, it is necessary to use the portable remote meter reading unit 5 (not shown in FIG. 3d) to initiate an exchange of data between the portable unit and each of the radio communication modules 2. At the same time, by pressing the button 70c on the portable control and display unit 7, the installer causes the measurement unit 6 to operate in the listening mode M₃ to enable said unit to intercept the response signal sent by each of the modules 2 and to measure the intensity of the intercepted signal. Finally, by means of the display means of the control and display unit 7, the installer verifies whether or not the received information corresponds to a radio link of sufficient quality between the modules 2 and the measurement mobile unit 6. It is considered here that at least three light-emitting diodes 72 of the set of four diodes corresponding to this test light. The installer then concludes directly, without having to interpret the results further, that the location is also satisfactory for a radio link between the modules 2 of the group G₁ and the measurement unit 6. At this stage of the tests, the installer may conclude that the location of FIGS. 3c and 3d corresponds to a possible future location for a first level intermediate collector. The installer then records the exact geographical coordinates, preferably in terms of position, including altitude, and antenna orientation. This may suffice for determining a location for the group G₁. Alternatively, this result may be used to test other potential locations for the group G₁ by repeating the step a2) for other geographical locations.

FIG. 3e illustrates application of the step a2) described above to deploying the network in the FIG. 3a context for the second group G₂ of meters 1; this figure illustrates more precisely the situation in which the position judged optimum for the link with the application point and for the radio communication modes has been determined at the first position. So as not to increase the number of figures, FIG. 3e shows the result of the test in the mode M₁ (see step a23 above) and the result of the test in the mode M₃ (see step a24 above), both tests leading the installer to conclude that the links between the measurement mobile unit 6 and the first mobile equipment 3, or between the radio communication modules 2 of the meters are of satisfactory quality. Once again, exact geographical coordinates of this location are recorded.

FIGS. 3f to 3h illustrate application of the step a3) described above to determine a second level location (coverage area Z₂) associated with the group G₃ of meters.

In practice, the installer does not know the extent of the first area Z₁ but the deployment assistance system assists in identifying when level changes. More precisely, FIG. 3f shows diagrammatically how the installer comes to realize that he/she is no longer in the first area Z₁, but in a higher level area Z₂. To this end, it suffices for the installer to become aware that it is impossible, after repeating above-described step a22), to find a location for which sufficient quality is obtained for the radio link between the measurement mobile unit 6 and the first mobile equipment 3, the test still being effected by means of radio control commands C from the control and display unit 7 of the unit 6 so that it operates in the access point/collector mode M₁.

Consequently, the installer knows that it is now necessary to seek to determine the second level location.

FIGS. 3g and 3h correspond to the tests effected on successive links to seek a second level location. The installer must proceed as follows to implement the step a3) described above:

a31) first placing the second mobile unit 4 (which simulates the radio receiver and repeater operation of an intermediate collector) at a first level location tested as satisfactory (see FIG. 3g);

a32) placing the measurement mobile unit 6 at a first location in an area close to the group G₂ of radio communication modules 2 associated with the meters 1 (see FIG. 3g);

a33) pressing the button 70b on the portable control and display unit 7, to cause the measurement unit 6 to operate in the collector/collector mode M₂; using the display means of the control and display unit 7 to verify whether or not the received information corresponds to a radio link of sufficient quality between the second mobile unit 4 and the measurement unit 6; it is assumed here that four light-emitting diodes 72 light; the installer then concludes, again directly, that this time the location is satisfactory for the radio link between the first mobile unit 3 and the measurement unit 6; otherwise, the installer would have had to repeat the test for another geographical location of the measurement unit 6;

a34) then checking whether the radio link between the measurement unit 6 and the radio communication modules 2 of the group G₃ is also satisfactory (FIG. 3h); to this end, the portable remote meter reading unit 5 (not shown in FIG. 3h) is used to initiate an exchange of data between the portable unit 5 and each of the radio communication modules 2; at the same time, pressing the button 70c of the portable control and display unit 7 causes the measurement unit 6 to operate in the listening mode M₃ to enable said unit to intercept the response signal sent by the modules 2 and to measure the intensity of the intercepted signal; finally, using the display means of the control and display unit 7, it is verified whether the received information corresponds to a radio link of sufficient quality between the modules 2 and the measurement unit 6 or not; it is considered here that at least three light-emitting diodes 72 of the set of four diodes corresponding to this test light; the installer then concludes directly, without having to interpret the results further, that the location is also satisfactory for a radio link between the modules 2 of the group G₃ and the measurement unit 6; at this stage of the tests, the installer may then conclude that the location of FIGS. 3g and 3h is a possible future location for a second level intermediate collector; these exact geographical coordinates are then recorded, preferably in terms of position, including altitude, and in terms of antenna orientation; just as for the first level, the installer may choose to stop there in respect of the determination of a location for the group G₂ or to use this result to test other potential locations by repeating the step a3).

FIG. 3i illustrates application of the step a4) described above to deployment of the network in the FIG. 3a context for the group G₄ of meters 1.

As in the previous situation (passage from area Z₁ to area Z₂) the installer does not know the extent of the first area Z₂ but, once again, the deployment assistance system gives assistance in determining when the level changes. Here, the installer realizes that he/she is no longer in the second level area Z₂ but in a higher level area Z₃ on realizing that it is impossible, after repeating the step a33) described above, to find a location for which sufficient link quality is obtained between the measurement mobile unit 6 and the second mobile equipment 4, the test again being effected by controlling the unit 6 from the control and display unit 7 so that it operates in the collector/collector mode M₂.

Consequently, the installer now seeks to determine the third level location. To this end, the procedure is exactly as described for the preceding steps a31) to a34), comprising placing the measurement mobile unit 6 at the third level location to be tested and the second mobile equipment 4 at a second level location previously judged satisfactory and testing, again in the same manner, both the quality of the link between the measurement unit 6 and the second equipment 4 (operating mode M₂) and also the quality of the link between the measurement unit 6 and each of the modules 2 of the group G₄ (operating mode M₃ combined with use of the portable remote meter reading unit 5). For simplicity, FIG. 3i illustrates the situation in which both tests at the first location are satisfactory.

Thus after performing all of the above tests using the deployment assistance system of the invention, the installer has recorded all the geographical positions (location and orientation) to be used for intermediate collectors when actually installing the network. The complete topology of the fixed network (positions of the access point, of the modules 2, and of the intermediate collectors) is thus determined completely, as shown in FIG. 3j.

Although not described in the context of network deployment (FIGS. 3a to 3j), it must be remembered that the portable control and display unit 7 is preferably also able to measure the occupancy level of the frequency used prior to any exchange with the measurement mobile unit 6 and to visually alert the installer if excessive frequency occupancy renders measurement impossible.

Although the system is described in the context of designing a new fixed network, it should be noted that it is equally simple to extend or to add to the coverage of an existing fixed network by using the deployment assistance system of the invention. For this it suffices, starting from the intermediate collectors already installed, to define progressively the additional intermediate collectors that it is necessary to add.

1-9. (canceled)

10. A system for assisting deployment of a fixed remote meter reading network, the fixed network to be deployed being of the type enabling an access point or main collector to recover measurement data transmitted by radio from a plurality of meters via a radio communication module associated with each meter and relayed to said access point or main collector via at least one intermediate collector, the system being characterized in that it includes:
a first mobile unit for simulating the radio operation of said access point or main collector;
a second mobile unit for simulating the radio receiver and repeater operation of an intermediate collector;
a remote meter reading portable unit able to exchange data with each radio communication module;
a measurement mobile unit for simulating the radio reception operation of an intermediate collector; and
a portable radio control and display unit;
in that the portable unit is able to control the operation of the measurement mobile unit by radio in three distinct operating modes:
an access point/collector mode in which the measurement mobile unit initiates radio communication with the first mobile unit for simulating the operation of the access point and effects a measurement indicating the intensity of the signal that it receives from the first mobile unit;
a collector/collector mode in which the measurement mobile unit initiates radio communication with the second mobile unit for simulating the operation of the intermediate collector and effects a measurement indicating the intensity of the signal that it receives from the second mobile unit; and
a listening mode in which the measurement mobile unit intercepts a response signal transmitted by a radio communication module in response to an interrogation signal sent by the portable remote meter reading unit and effects a measurement indicating the intensity of the intercepted signal;
and in that the portable unit is able to receive by radio said measurement effected in each of the three operating modes and includes means for displaying information relating to the quality of the link determined from said measurement.

11. A system according to claim 10, characterized in that the portable unit includes three manual control buttons for causing the measurement mobile unit (6) to operate in one of the three operating modes.

12. A system according to claim 10, characterized in that the display means of the portable unit include light-emitting diodes.

13. A system according to claim 12, characterized in that the display means include three sets of light-emitting diodes, each set being assigned to displaying information relating to the quality of the link for one of the three operating modes, and in that a plurality of diodes of each set is lit as a function of the quality of the link.

14. A system according to claim 13, characterized in that each set of light-emitting diodes includes four light-emitting diodes, and in that if the number of diodes lit is equal to two it may be concluded that the radio link is satisfactory.

15. A system according to claim 10, characterized in that the portable radio control and display unit is further adapted to measure automatically the frequency occupancy level used for communication prior to any radio exchange between the portable unit and the measurement mobile unit.

16. A system according to claim 15, characterized in that the portable control and display unit includes an additional light-emitting diode that is lit if the frequency occupancy level is above a predetermined threshold.

17. A system according to claim 10, characterized in that all radio communication is effected in the UHF band, including at 868 MHz.

18. Use of the system according to claim 10, for assisting deployment of a fixed remote meter reading network for reading measurement data from a plurality of meters transmitted via a radio communication module associated with each meter, characterized in that it consists in:
a1) placing the first mobile unit for simulating the radio operation of said access point or main collector at the required future location of the access point or main collector of the network;
a2) determining for each group of radio communication modules associated with meters situated at least partially in a first coverage area of the access point the future geographical location of a first level intermediate collector by using the portable unit to cause the measurement mobile unit to operate successively in the access point/collector mode and in the listening mode for one or more positions of the measurement mobile unit and recording the position information corresponding to the first position of the measurement mobile unit for which the information obtained on the display means of the portable unit corresponds to a radio link of sufficient quality for the access point/collector mode and for the listening mode;
a3) determining for each group of radio communication modules associated with meters situated at least partially in a coverage area of the access point that is larger than the first coverage area, determining the future geographical location of a second level intermediate collector by placing the second mobile equipment in the position designated by the positioning information recorded at the first level by using the portable unit to cause the measurement mobile unit to operate successively in the collector/collector mode and in the listening mode for one or more positions of the measurement mobile unit, and recording the geographical coordinates of the first position for which the information obtained on the display means of the portable unit corresponds to a radio link of sufficient quality both in the collector/collector mode and in the listening mode;
a4) repeating step a3) to determine optimum future locations for the collectors of each level higher than the second level on moving away from the access point, the second mobile unit being placed at one of the positions determined for the immediately lower level and the measurement mobile unit being placed at different positions of said higher level.
